(19) United States
(12) Patent Application Publication
(10) Pub. No.: US 2009/0269567 A1
(43) Pub. Date: Oct. 29, 2009

(54) Thermal Barrier, an Article with a Thermal Barrier and a Method of Applying a Thermal Barrier to a Surface

(75) Inventor: Andrew Robert McCabe, Didcot (GB)

Correspondence Address: ROTHWELL, FIGG, ERNST & MANBECK, P.C., 1425 K STREET, N.W., SUITE 800, WASHINGTON, DC, 20005, US

(73) Assignee: ZIRCOTEC LTD., Didcot (GB)

(21) Appl. No.: 12/429,535

(22) Filed: Apr. 24, 2009

(30) Foreign Application Priority Data
Apr. 25, 2008 (GB) 0807627.5

(51) Int. Cl. C01G 23/047; C04B 35/00; B32B 15/04; C23C 4/10

(52) U.S. Cl. 428/220; 423/610; 501/94; 428/469; 427/453

(57) ABSTRACT

A thermal barrier comprises a coating of titanium dioxide or a blend of titanium dioxide with at least one other ceramic material.

### BACKGROUND OF THE INVENTION

This invention relates to a thermal barrier, an article with a thermal barrier and a method of applying a thermal barrier to a surface.

A known situation in which a heat shield is required is for an exhaust for a vehicle such as a car or motorcycle. The heat from the exhaust and associated engine, particularly on performance vehicles, is such that there is the potential for heat damage to surrounding components, and a risk of setting fire to combustible materials, such as dry grass, coming into contact with the system, as well as the risk of skin burns for any person coming into contact with the hot system.

There are currently two known solutions:
1. It is possible to provide mechanical casings with internal air-gap or thermal insulant, physical guards and heat shields. However, this is generally unsightly and costly. Furthermore, it takes up precious space and adds weight to the vehicle.
2. It is also possible to apply a thermal insulation material (eg. zirconia oxide) directly to the inside and/or outside of the system. This can be through painting or plasma spraying. This insulation material is unsightly in its natural form (its natural colour is white/yellow), is porous unless painted, and is susceptible to stone chips, thermal shock (from road surface water), discolouration and staining. Although discolouration and staining are not an issue when applied to hidden and protected components, it is far less acceptable where the coating is exposed and visible, for example on a car tail-pipe or motorcycle exhaust.

### SUMMARY OF THE INVENTION

According to a first aspect of the present invention, there is provided a thermal barrier comprising a coating including titanium dioxide.

Preferably, the coating is selected from the group comprising: titanium dioxide only; and titanium dioxide and at least one other ceramic material.

According to a second aspect of the present invention, there is provided a thermal barrier comprising a coating of titanium dioxide or a blend of titanium dioxide with at least one other ceramic material.

The thermal barrier of the invention is extremely tough, hard-wearing, scratch resistant, resistant to stone chips, resistant to corrosion and/or chemical attack, and is highly resistant to thermal shock.

The thermal barrier is preferably a thermal sprayed coating and most preferably is a plasma sprayed coating. Titanium dioxide is naturally white, but loses oxygen during the plasma spray process and as a result changes colour. The plasma sprayed ceramic coating has a satin black sheen, which could be considered more attractive than the natural white or pale colours of most ceramics. The plasma sprayed coating has the further advantage of retaining its consistent appearance when heated (unless excessively), unlike, for example, metallic exhaust pipes, which may show decolourisation.

A high level of porosity in the coating further increases the thermal resistance. The porosity may be at least 5%, preferably at least 10%. The quantity of pores may be sufficient to produce fine cracks in the ceramic, the cracks not resulting in total failure of the ceramic. The fine cracks further increase the voidage in the ceramic coating, thereby enabling the thermal resistance to be increased, without deleteriously affecting the coating to the extent that it fails and becomes detached from the surface to be coated.

Where the coating is a blend of titanium dioxide with at least one other ceramic material, preferably the coating comprises greater than about 20 wt.-% titanium dioxide, more preferably 30% or more. and may include 50% or more. The other ceramic material may be added to change and control the properties of the barrier such as the final colour, surface finish, texture and physical properties of the barrier. Where the coating is a blend, the or each other ceramic material may be any suitable ceramic material, but preferably the blend includes at least one of zirconium dioxide, chromium dioxide, aluminium oxide, and magnesium zirconate.

The thermal barrier may be of constant thickness. In an alternative embodiment, the coating may have different thicknesses in different places to provide different degrees of protection from heat. The thermal barrier may have a thickness of at least 30 micrometres and preferably is at least 50 micrometres in thickness, more preferably at least 100 micrometres. The thicker the coating, the better its thermal barrier properties. Preferably the thermal barrier is not more than 500 micrometres in thickness.

The thermal barrier may be for a vehicle engine component, and in particular may be for an exhaust.

According to a third aspect of the present invention, there is provided an article with a thermal barrier according to the first aspect of the invention.

The article is preferably made of metal, and may be made of steel. The article may be a vehicle engine component, and may be an exhaust, preferably an automotive exhaust. In particular the article may be a car tailpipe or a motorcycle exhaust.

The article may include at least one intermediate layer beneath the thermal barrier. The at least one intermediate layer may comprise a material selected from the group comprising a metal and a metal alloy. The intermediate layer may be a nickel-containing layer.

According to another aspect of the invention there is provided a method of applying a thermal barrier to a surface by thermally spraying onto the surface a source containing titanium dioxide.

The source may be solely titanium dioxide or the source may comprise titanium dioxide and at least one other ceramic material.

According to a further aspect of the present invention, there is provided a method of applying a thermal barrier to a surface by thermally spraying onto the surface a source containing titanium dioxide or a blend of titanium dioxide and at least one other ceramic material.

Thermal spraying is a desirable deposition method, as a controllable amount of porosity can be introduced into the coating. Preferably the thermal spraying is conducted by plasma spraying, and more preferably by nitrogen plasma spraying.

Preferably the surface is roughened prior to spraying of the thermal coating, for example by grit blasting. Roughening of the surface improves the chemical and physical activity of the surface, and increases the surface area, thus improving the coating bond strength.

Preferably the method further comprises applying a bond coat to the surface before applying the thermal barrier. The bond coat may be selected from the group comprising a metal and a metal alloy, and may contain nickel. The bond coat provides a more secure bond between the thermal barrier coating and the surface to be coated. In addition it minimises the effect of thermal mismatch between the surface and the ceramic top coat.

Where the source is a blend of titanium dioxide with at least one other ceramic material, preferably the source comprises greater than about 20 wt.-% titanium dioxide, more preferably 30% or more. and may include 50% or more. The other ceramic material may be added to change and control the properties of the barrier such as the final colour, surface finish, texture and physical properties of the barrier. Where the source is a blend, the or each other ceramic material may be any suitable ceramic material, but preferably the blend includes at least one of zirconium dioxide, chromium dioxide, aluminium oxide, and magnesium zirconate.

According to a further aspect of the invention there is provided the use of thermal sprayed titanium dioxide alone or in combination with another ceramic material as a thermal barrier.

According to another aspect of the invention there is provided the use of plasma sprayed titanium dioxide alone or in combination with another ceramic material as a thermal barrier.

### DETAILED DESCRIPTION OF THE PREFERRED EMBODIMENTS

Embodiments of the invention will now be described by way of example.

### Embodiment 1

In this embodiment, a thermal barrier coating was applied to a mild steel exhaust pipe.

Before coating, the exhaust pipe was thoroughly degreased, inside and out, using acetone. Areas not requiring coating were masked off using proprietary masking tape. The pipe was grit blasted to give a rough surface, using a siphon-type grit blast system at 2.76 bar (40 psi) with 0.4 to 0.5 mm aluminium oxide grit.

The roughened pipe was mounted in a rotating chuck, in a plasma spray booth equipped with a robot manipulation system. The robot was programmed to spray the rotating pipe.

A nickel based bond coat comprising nickel −40% aluminium was plasma sprayed onto the pipe to a thickness of ˜100 μm. The plasma spray parameters used were Nitrogen 50 slpm, hydrogen 5 slpm, current 400 Amps, carrier gas 5 slpm, spray distance 100 mm, powder flow 45 g/min.

The thermal barrier coating was then applied by plasma spraying a 50/50 wt.-% mixture of titanium dioxide and magnesium zirconate on top of the bond coat. The thermal barrier coating was applied to a thickness of ˜200 μm. The plasma spray parameters used were Nitrogen 45 slpm, hydrogen 5 slpm, current 500 Amps, carrier gas 5 slpm, spray distance 75 mm, powder flow 65 g/min, ceramic powder particle size 50 to 90 micrometres. The ceramic was plasma sprayed so that the resulting coating was of graduated thickness being thicker nearer to inlet end of the exhaust pipe and thinner nearer to the outlet end.

After the coatings had been applied, the masking tape was removed, leaving a deep grey/black coating in the required areas on the pipe.

The exhaust pipe was then tested for thermal shock properties by heating to 500° C. then immersing in water at 20° C., and repeating that process thirty times. The exhaust coating showed no signs of failure, and the test had no impact on its appearance. Longer term testing in which the exhaust was subject to an accelerated twenty year lifetime test, showed that the exhaust and its coating remained intact and operable, without corrosion, and still acceptable in appearance, thereby extending the operating life of the overall system.

Porosity was typically 10%, with a thermal conductivity of 2 W/mK .

### Embodiment 2

In this embodiment, a thermal barrier coating was applied to a stainless steel heat shield.

The heat shield was prepared in the same way as the exhaust pipe in embodiment 1.

The robot was programmed to perform a ladder movement across the heat shield.

A nickel based bond coat was applied as in embodiment 1.

The thermal barrier coating was then applied by plasma spraying 100 wt. % titanium dioxide using the same parameters as in embodiment 1

The resulting thermal coating was black.

The weight increase was used to determine the coating thickness which was 200 μm

The properties were similar to those in embodiment 1.

### Embodiment 3

In this embodiment, a thermal barrier coating was applied to an exhaust manifold.

The exhaust manifold was prepared in the same way as the parts in embodiments 1 and 2.

As the exhaust manifold had a complex shape, plasma spraying was carried out using a hand held plasma spray gun.

A nickel based bond coat, of the same composition as that the bond coats used in embodiments 1 and 2 was applied as a thin even layer.

The thermal barrier coating was then applied by plasma spraying a 40/60 wt.-% mixture of fine particle size TiO₂ and A1₂O₃, namely 20 to 50 μm particle size powder. Due to the fine powder particle size, the carrier gas flow was increased to 8 slpm, the spray distance decreased to 65 mm and powder flow rate decreased to 40 g/min compared to the spray parameters in embodiments 1 and 2. The spray parameters were otherwise unchanged.

The resulting thermal barrier coating was a deep grey/black. The appearance was uneven until final cleaning took place, using a compressed air line to remove loosely bonded unmelted powder particles.

What is claimed is:

1. A thermal barrier comprising a coating including titanium dioxide.

2. A thermal barrier as claimed in claim 1, comprising a coating selected from the group comprising: titanium dioxide only; and titanium dioxide and at least one other ceramic material.

3. A thermal barrier according to claim 1, wherein the coating comprises greater than about 20 wt.-% titanium dioxide.

4. A thermal barrier according to claim 1, wherein the coating includes at least one of zirconium dioxide, chromium dioxide, aluminium oxide, and magnesium zirconate.

5. A thermal barrier according to claim 1, wherein the thermal barrier is a thermal sprayed coating.

6. A thermal barrier according to claim 1, wherein the thermal barrier has different thicknesses in different places to provide different degrees of protection from heat.

7. A thermal barrier according to claim 1, wherein the thermal barrier has a thickness of at least 30 micrometres.

8. An article with a thermal barrier according to claim 1.

9. An article according to claim 8, wherein the article is made of metal.

10. An article according to claim 8, wherein the article is made of steel.

11. An article according to claim 8, wherein the article is an automotive exhaust.

12. An article according to claim 8, wherein the article includes at least one intermediate layer beneath the thermal barrier.

13. An article according to claim 12, wherein the at least one intermediate layer comprises a material selected from the group comprising a metal and a metal alloy.

14. An article according to claim 12, wherein the intermediate layer is a nickel-containing layer.

15. A method of applying a thermal barrier to a surface by thermal spraying onto the surface a source containing titanium dioxide.

16. A method as claimed in claim 15, wherein the source is one selected from the group comprising: sol ely titanium dioxide; and titanium dioxide and at least one other ceramic material.

17. A method according to claim 15, wherein the thermal spraying is plasma spraying.

18. A method according to claim 15, wherein the method further comprises applying a bond coat to the surface before applying the thermal barrier.

19. A method according to claim 18, wherein the bond coat is one selected from the group comprising a metal and a metal alloy.

20. A method according to claim 18, wherein the bond coat contains nickel.
